(19) United States
(12) Patent Application Publication
(10) Pub. No.: US 2013/0182419 A1
(43) Pub. Date: Jul. 18, 2013

(54) PORTABLE LIGHT, AND SWITCH, HEAT SINK AND CHARGING MODULE THEREFOR

(71) Applicant: William Douglas WORMAN, Audubon, PA (US)

(72) Inventor: William Douglas WORMAN, Audubon, PA (US)

(21) Appl. No.: 13/349,239

(22) Filed: Jan. 12, 2012

(51) Int. Cl. F21L 4/08; F21V 29/00

(52) U.S. Cl. 362/183; 362/294; 362/373

(57) ABSTRACT

A portable light may include a light housing, a light source module and a switch. A light source module may include a thermally conductive module housing and a switch housing that fit together and have an exterior size and shape for being disposed in a light housing. The module includes a light source thermally coupled to the module housing, a control circuit for controlling the light source, an electrical switch actuatable from exterior the module and supported by the switch housing, and at least one contact.

The present invention relates to a portable light and, in particular, to a portable light and a switch, heat sink and charging module therefor.

As flashlights and other portable lights have evolved to include solid state electronic technology in addition to the usual elements of such lights, such as a light source, battery switch and housing, the number of components contained in a typical light has increased dramatically. For example, simple conventional lights may include a tubular housing open at one end and having a switch contact fastened thereto, a battery, a reflector and lamp, and a lens and lens ring that contain the battery, reflector and lamp in the housing. Lamps typically connect directly to the battery without the need for further circuitry beyond electrical conductors to complete an electrical circuit. With so few elements, assembly and disassembly of such lights is a simple matter of mechanical assembly.

With the advent of solid state light sources, e.g., light emitting diode (LED) light sources, however, the need for circuitry to regulate and control the application of electrical power to the LED came to the fore, both with respect to controlling the voltage and/or current applied to the LED as well as to controlling the light output and extending the operating time obtainable from a given battery power source. This circuitry typically requires a heat sink for removing heat from certain electronic components, e.g., the LED, and typically employs dozens of electronic components and one or more circuit boards for carrying such components, as well as connections between increasingly complex controls and/or actuators and control circuitry.

Further, in modern electronic lights simple metal strip electrical conductors alone do not suitably provide the different electrical connections desired for power carrying and signal carrying connections. Thus, electrical wires and other forms of conductors and/or connectors can be required or desired. In addition, assembly of modern electronic lights involves more than simple mechanical assembly, e.g., due to the need for making connections to electronic components and for the thermal mounting of certain components.

Applicant believes there may be a need for a portable light and module that can allow the more technically difficult assembly operations to be made under more controlled conditions while also allowing for relatively simple final assembly that can be performed without highly skilled technical labor and that facilitates normal repair and maintenance, e.g., in replacing batteries or other major components.

Accordingly, a light and module may comprise: a light housing 20 having a cavity therein for receiving a module and a source of electrical power; a module having an exterior size and shape disposed in the cavity of the light housing, the module 100 comprising: a module housing generally defining a substantial portion of the exterior size and shape and including a thermally conductive material; a light source thermally coupled to the module housing, a switch housing engaging the module housing and generally defining another substantial portion of the exterior size and shape, the switch housing including an electrical switch actuatable from exterior the module; at least one electrical contact extending from the module for making electrical connection to a source of electrical power; and a control circuit coupled to the light source and to the at least one electrical contact for controlling the light source responsive to actuation of the electrical switch; a reflector adjacent the light source for directing light produced thereby; and a lens retainer retaining a lens adjacent the reflector; the light housing having an opening wherein the electrical switch is actuatable from exterior the light housing.

According to a further aspect, a light module may comprise: a module having an exterior size and shape disposable in a cavity of a light housing; the module may comprise: a module housing generally defining a substantial portion of the exterior size and shape, and including a thermally conductive material; a light source thermally coupled to the module housing; a switch housing engaging the module housing and generally defining another substantial portion of the exterior size and shape, the switch housing including an electrical switch actuatable from exterior the module; at least one electrical contact extending from the module for making electrical connection to a source of electrical power; and a control circuit coupled to the light source and to the at least one electrical contact for controlling the light source responsive to actuation of the electrical switch.

### BRIEF DESCRIPTION OF THE DRAWING

The detailed description of the preferred embodiment(s) will be more easily and better understood when read in conjunction with the FIGURES of the Drawing which include:

FIG. 1 is a perspective view of an example embodiment of a flashlight;

FIG. 2 is an exploded perspective view of the example embodiment of a flashlight;

FIG. 3 includes FIGS. 3A and 3B which are perspective views of an example embodiment of a module of the example embodiment of a flashlight;

FIG. 4 includes FIGS. 4A and 4B which are exploded perspective views of an example embodiment of a module of the example embodiment of a flashlight;

FIG. 5 is a longitudinal cross-sectional view of the example embodiment of a flashlight, and includes FIGS. 5A and 5B which are enlarged longitudinal cross-sectional views of a portion of the light of FIG. 5 for an example embodiment of an example module of the example embodiment of a flashlight, FIG. 5C which is an enlarged transverse cross-sectional view of the portion of FIG. 5, and FIG. 5D which is a longitudinal cross-sectional view of a portion on the example module; and

FIG. 6 is a schematic diagram of example electronic circuitry suitable for use in the example embodiment of a flashlight.

In the Drawing, where an element or feature is shown in more than one drawing figure, the same alphanumeric designation may be used to designate such element or feature in each figure, and where a closely related or modified element is shown in a figure, the same alphanumerical designation primed or designated “a” or “b” or the like may be used to designate the modified element or feature. According to common practice, the various features of the drawing are not to scale, and the dimensions of the various features may be arbitrarily expanded or reduced for clarity, and any value stated in any Figure is given by way of example only.

### DESCRIPTION OF THE PREFERRED EMBODIMENT(S)

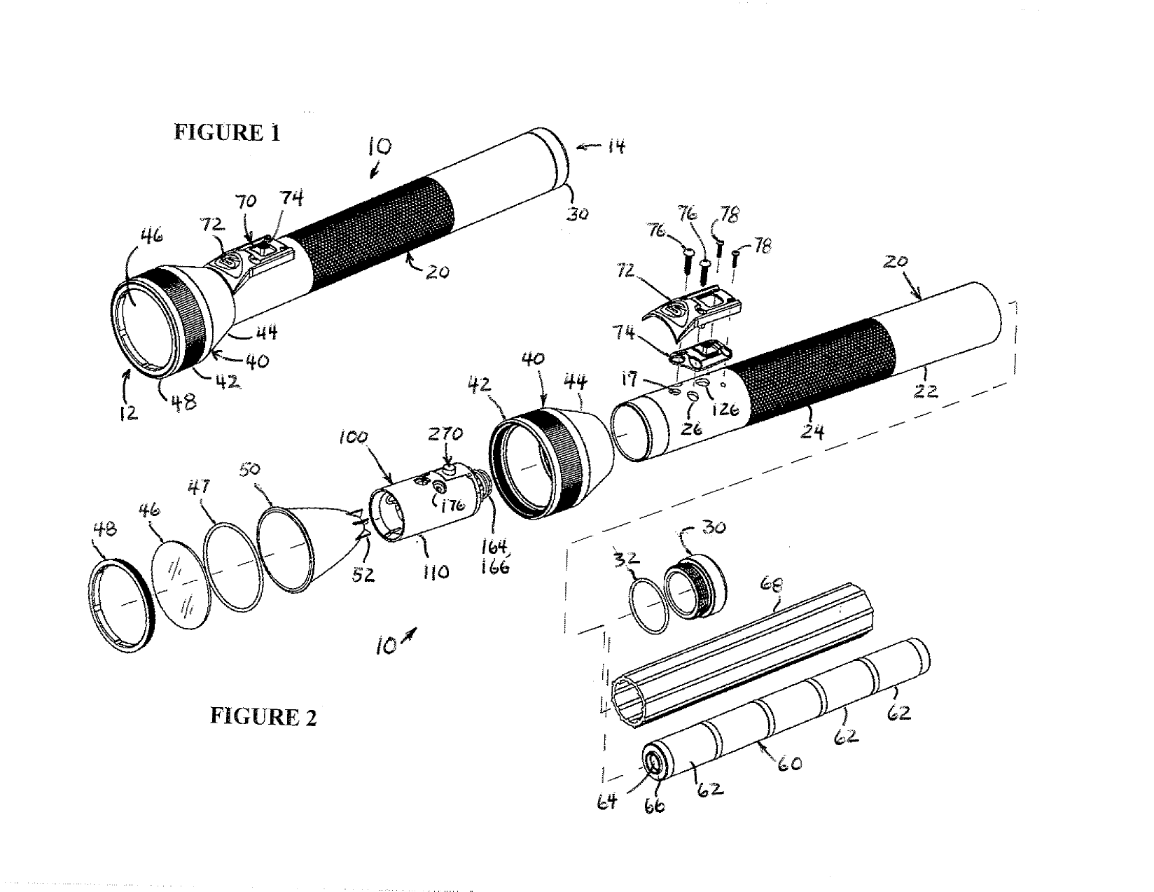

FIG. 1 is a perspective view of an example embodiment of a flashlight 10 and FIG. 2 is an exploded perspective view thereof. Flashlight 10 is a portable light comprising a body 20 having a head end 12 or light producing end 12 at one end of body 20 and having a rear or tail end 14 at the opposite end of body 20. Body 20 includes a housing or barrel 22, typically an elongated hollow cylindrical tube optionally having a gripping area 24 thereon which may be knurling or another pattern in the exterior of housing 22 or may be a separate grip 24, e.g., a rubber, silicone or other plastic grip 24, thereon, residing either on the surface thereof or in a recess in the surface thereof.

Light 10 typically emits light at forward end 12 thereof from a light source therein that is powered by batteries 60, 62 contained therein and controlled by a switch actuator 74 of an external switch 70 located on light body or light housing 20. In the illustrated example, switch 70 includes a switch cover or bezel 72 that is generally rectangular and that has an opening through which actuator 74 is accessible, wherein actuator 74 is preferably part of a generally rectangular resilient member that is disposed between switch bezel 72 and body 20, e.g., housing 22, so as to serve both as an actuator member 74 and as a seal or gasket 74 between bezel 72 and housing 22. Switch 70 including bezel 72 and actuator 74 is retained to body 20 by one or more fasteners 76, 78; in a preferred arrangement fasteners 76 also serve as external electrical contacts for connecting light 10 to a battery charger, e.g., as when light 10 is inserted into a charging “sleeve” that has contacts for making electrical connection with fasteners 76, for charging a rechargeable battery 60, 62 therein.

Tail end 14 includes a tail cap 30 that engages housing 22 to close the rearward end thereof, e.g., by threadingly engaging threads of housing 22, and may optionally be sealed with an O-ring 32 to resist the entry of moisture, dirt, debris and other unwanted material. Typically, tail cap 30 may be removed to allow installation, removal and/or replacement of a battery 60 that is disposed in an internal cavity of body 20.

A battery 60 may include one or more battery cells 62 which may be individually packaged battery cells 62 or may be plural battery cells 62 that are packaged together as a battery assembly 60. In a packaged battery assembly, it may be desirable to include an electrical conductor to provide a connection to the rear most one of series connected battery cell 62 so that concentric battery contacts 64, 66 may be provided. Typically, the central contact 64 connects to or is a central terminal on the forward end of the forward most battery cell 62, which in many instances is a positive terminal, whereas the outer annular contact 66 connects to or is part of the electrical conductor that connects to the rear terminal of the rear most battery cell 62. A sleeve 68, typically an insulating sleeve 68, may be provided to enclose battery cells 62, and sleeve 68 may be a part of battery assembly 60, e.g., a sleeve that retains battery cells 62 in their respective locations, or may be an insert into housing 22.

Head end 12 may include a head assembly 40 which may have, but need not have, a relatively larger diameter than does housing 20. Head end 40 typically includes a head housing 40 that has a cylindrical portion 42 optionally having knurling or another grip enhancing pattern 42 thereon and a conical portion 44 providing a transition between the relatively larger diameter of cylindrical portion 42 and housing 22. Head assembly 40 further includes a light source that when energized produces light that is projected outward through lens 46 which is retained on head housing 40 by a lens retainer 48, sometimes referred to as a lens ring or lens cap or face cap 48, that engages the forward end of head housing 40, e.g., by threading onto threads of housing portion 42. Lens 46 and lens retainer 48 may optionally be sealed with an O-ring 47 or gasket 47 to resist the entry of moisture, dirt, debris and other unwanted material.

Housing 22 and head housing 40 may be separate pieces (as illustrated) that are assembled together to provide light housing 20 or light body 20, e.g., by threaded engagement where field disassembly may be desired or by being press fit together where field disassembly is not required or desired. Alternatively, head 40 and housing 22 may be assembled and the forward end of housing 22 may be formed outwardly so as to retain the end of housing 22 in head 40. Also alternatively, and equally acceptably, housing 22 and head housing 40 may be an integral piece, e.g., as by molding or casting or machining light body 20 as a single piece.

Disposed internally to light 10 is a module 100 that provides plural elements and functions for light 10, as will be described. While module 100 is typically inserted into body 20 through head housing 40, it may be disposed in housing 22 of body 20 as in the example embodiment illustrated or may be disposed in head housing 40 of body 20. Module 100 includes a module housing 110 having a generally open forward end into which the rearward smaller end of a light shaping reflector 50 resides for shaping the light produced by a light source of module 100 that is located near the forward end thereof. Module 100 preferably has one or more contacts 164, 166 at the rearward end thereof, e.g., two concentric spring contacts 164, 166, arranged to make electrical connection to the respective contacts 64, 66 of battery 60, e.g., concentric contacts 64, 66 thereof, when a battery 60 is in the cavity of housing 22.

Receptacles 176 of module 100, when module 100 is properly positioned in body 20, align with holes 26 through body 20 and corresponding holes through bezel 72 and actuator 74 to receive fasteners 76 which engage receptacles 176 of module 100 for retaining module 100 in light housing or light body 20 and for making electrical connection between module 100 of light 10 and an external charger for battery 60, 62 of light 10. When module 100 is so positioned in light housing/body 20, actuator 74 of switch assembly 70 is adjacent to an electrical switch 270 of module 100 for being actuated for controlling operation of light 10 and the light produced by the light source therein, e.g., in module 100. One or more additional fasteners 78 may also be employed for retaining module 100 in light body 20, e.g., typically in housing 22 thereof, and/or for retaining bezel 72.

Thus, module 100 provides plural functions including some or all of supporting a light source adjacent reflector 50, providing battery contacts 164, 166 for making connection to a battery 60, 62, providing external charging contacts 76 for charging battery 60, 62, and controlling operation of the light source via actuation of switch 270 to produce light. Further, the arrangement locating module 100 in light body 20, e.g., typically in housing 22 thereof, also serves for locating contacts 164, 166 in proper locations for connecting to battery contacts 64, 66 and for locating the light source and reflector 50 in a proper respective locations for shaping the light produced by the light source.

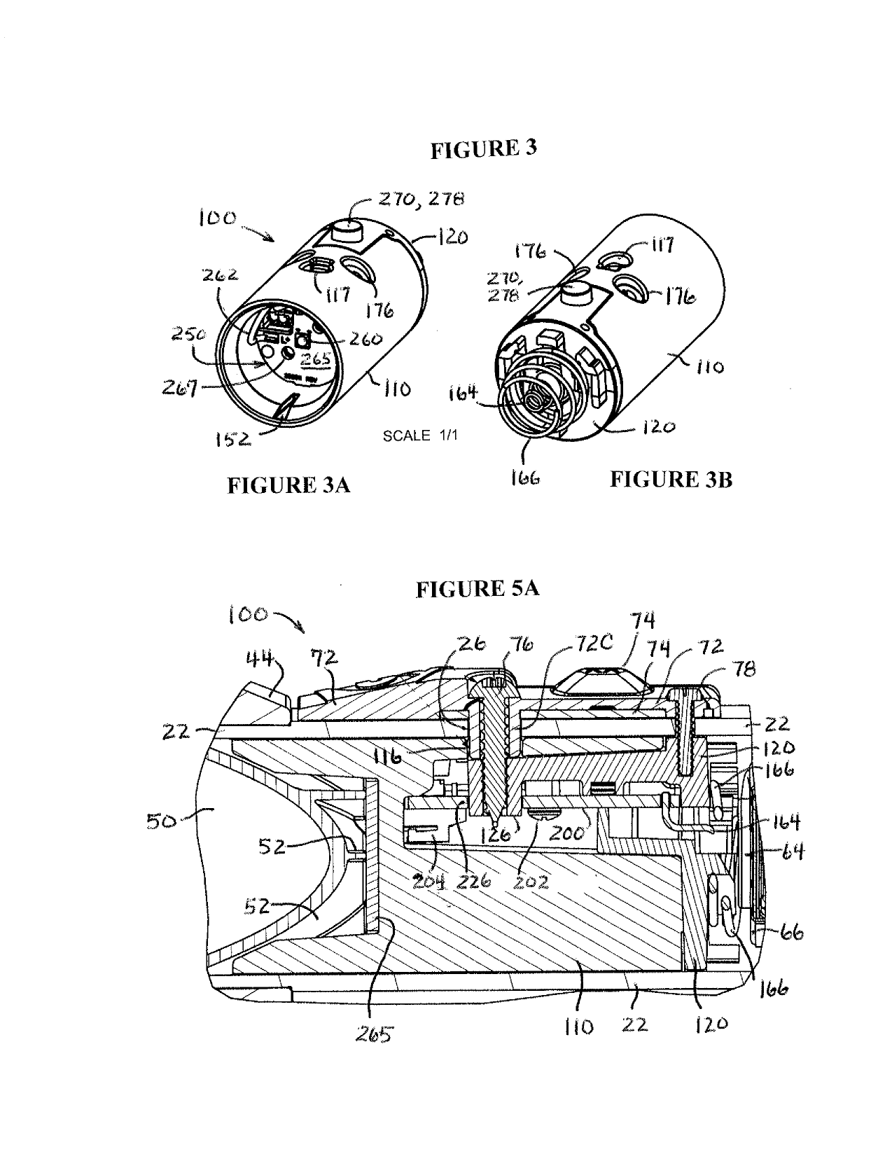

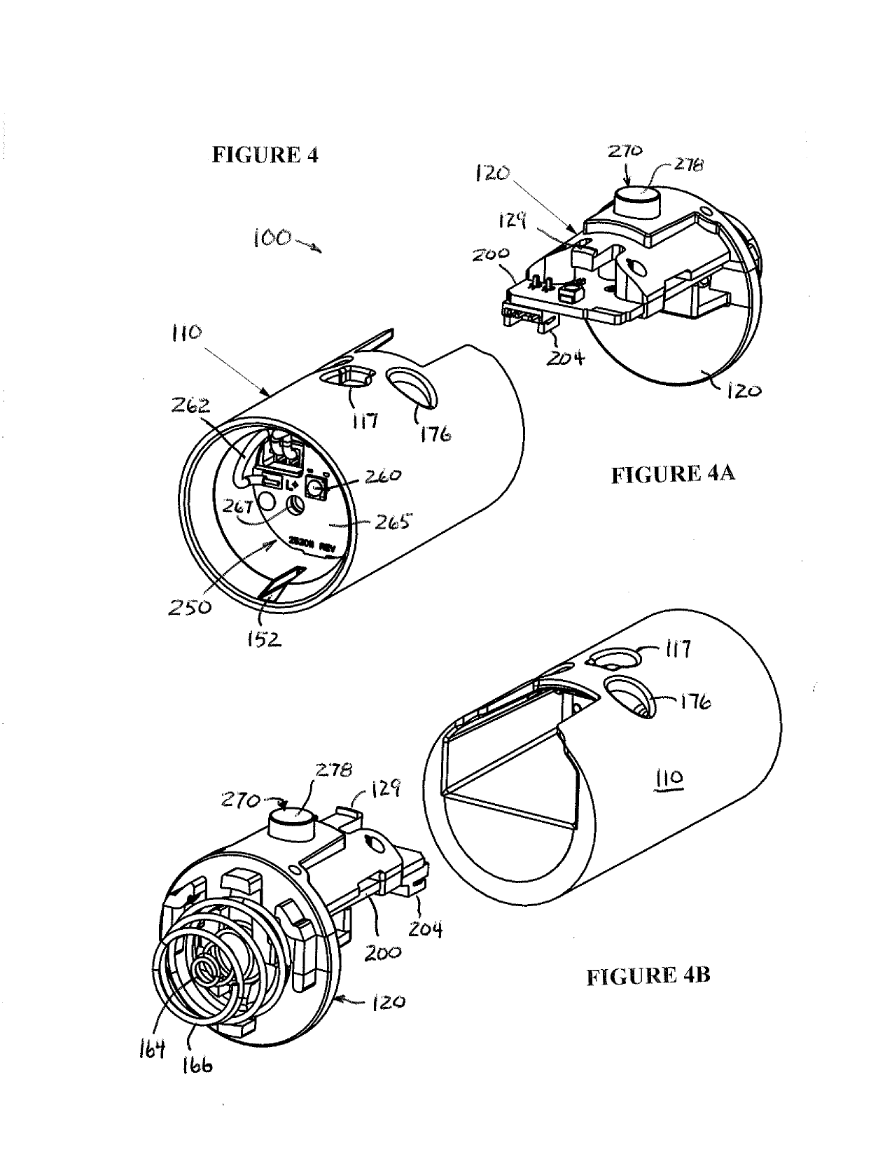

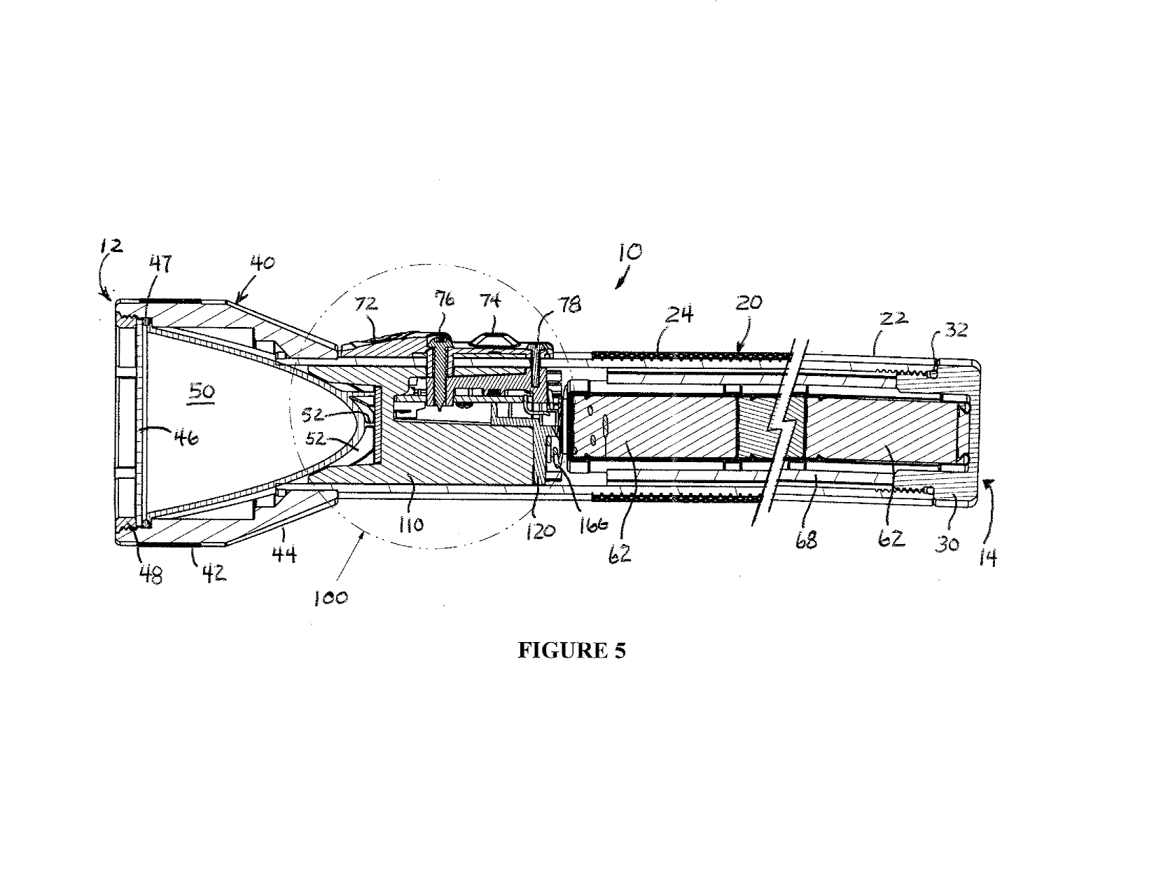

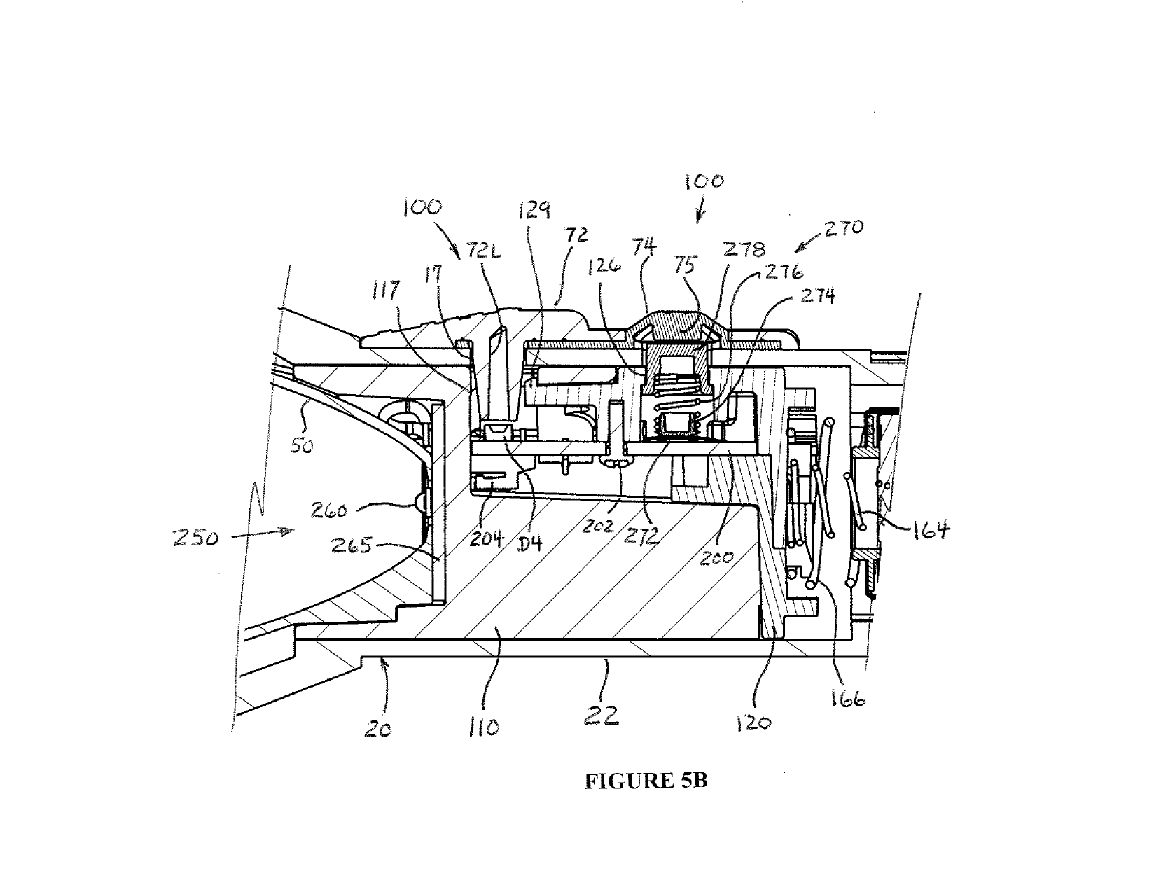

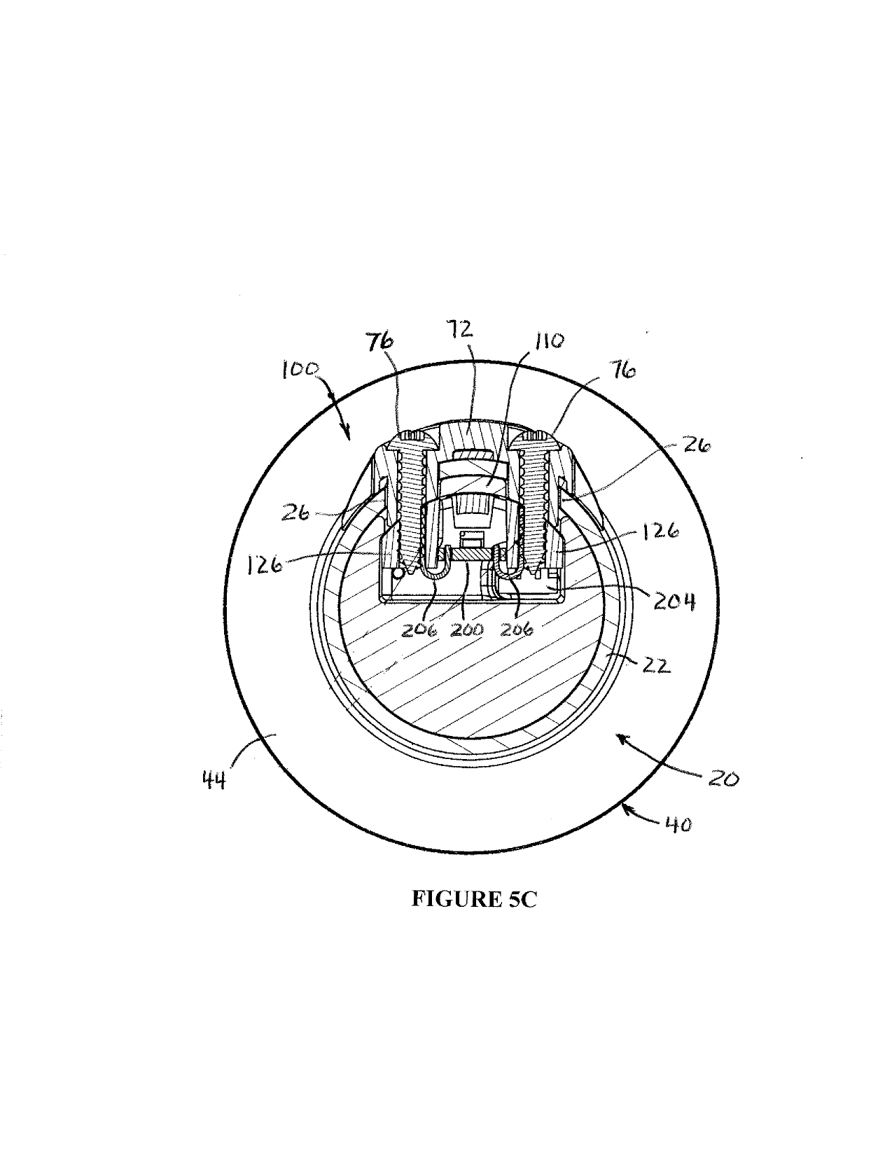

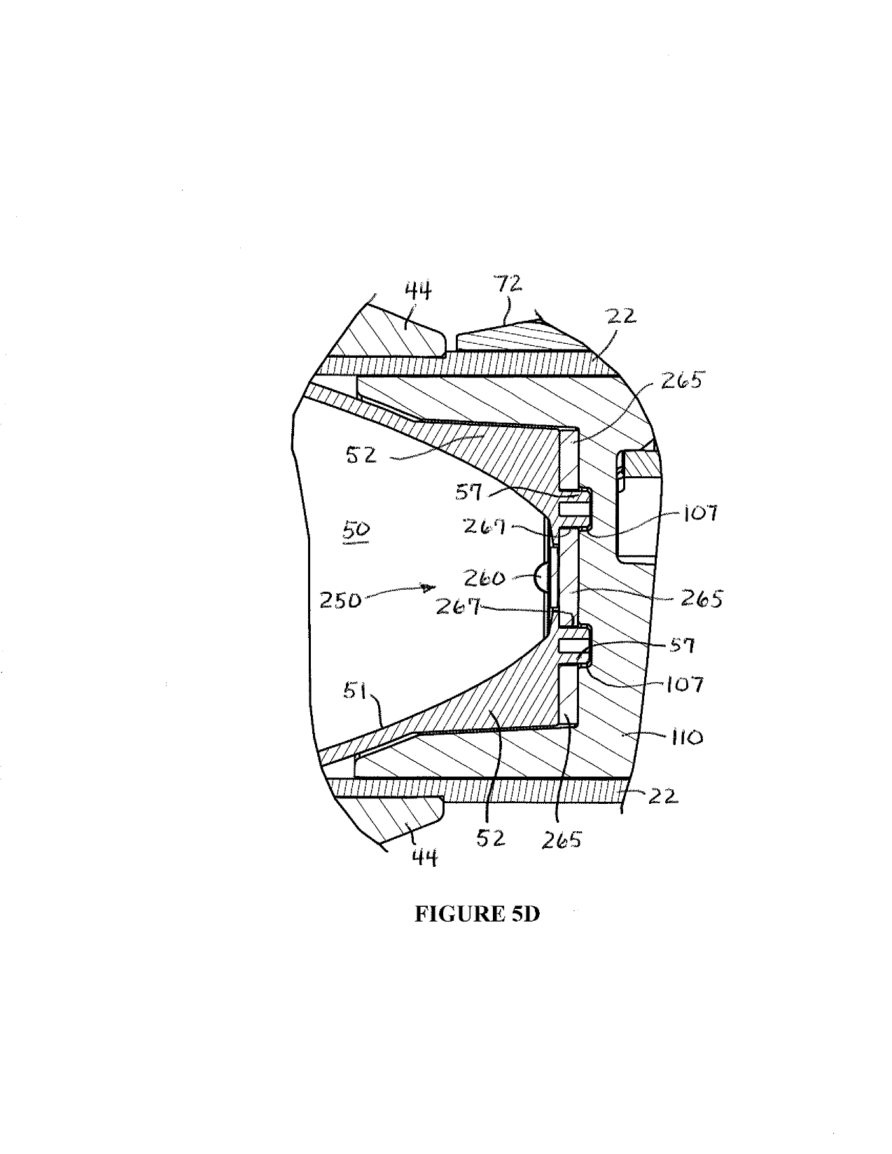

FIG. 3 includes FIGS. 3A and 3B which are perspective views of an example embodiment of a module 100 of the example embodiment of a flashlight 10; and FIG. 4 includes FIGS. 4A and 4B which are exploded perspective views of an example embodiment of a module 100 thereof. FIG. 5 is a longitudinal cross-sectional view of the example embodiment of a flashlight 10 (with a portion of the battery compartment abbreviated), and includes FIGS. 5A and 5B which are enlarged longitudinal cross-sectional views of a portion of the light 10 of FIG. 5 for an example embodiment of a module 100 of the example embodiment of a flashlight 10, FIG. 5C which is an enlarged transverse cross-sectional view of the portion of FIG. 5 for the example module 100, and FIG. 5D which is a longitudinal cross-sectional view of a portion on the example module 100. The longitudinal cross-section of FIGS. 5 and 5A is offset to one side of the center of light 10 so as to show certain details of the arrangement of fastener 76, bezel 72, light housing 20, switch housing 120 and circuit board 200, while the longitudinal cross-section of FIG. 5B is generally through the center of module 100 to show the arrangement of circuit board 200 and elements 272-278 of electrical switch 270 therein.

Module 100, which may be referred to as a switch module 100 or as a light source module 100 or as an LED/switch module 100, includes a thermally conductive housing 110 or heat sink 110 and an electrically insulating switch housing 120. Housing and heat sink 110 is thermally conductive so as to provide a heat sink 110 for the light source 250 mounted near the forward end thereof and for electronic circuitry on electronic circuit board 200. Switch housing 120 slips into a central cavity of housing 110 from the rearward end thereof and supports an electronic circuit board 200 which carries electronic circuitry for controlling operation of light source 250 responsive to actuation of electrical switch 270, e.g., via extension 75 extending inward from external actuator 74. Switch housing 120 is retained in heat sink housing 110 by aligning and interlocking members associated with fasteners 76 as described.

Module housing 110 has openings 116 of similar size and spacing to openings 26 of light housing or body 20 and housing 22 thereof, wherein openings 116, 26 align when module 100 is properly positioned in light body 20. Switch bezel 72 has hollow projections 72C and 72L that are generally cylindrical and/or conical and that extend into openings 26, 116 and 117 so as to locate and retain module 100 in the proper position in light body 20 and housing 22. Switch housing 120 has holes 176 that align with openings 26, 116 to receive fasteners 76, and a pair of wires 206 extend from circuit board 200 into each of holes 176 for providing an electrical connection between fastener 76 and circuit board 200, whereby respective electrical connections can be made between circuit board 200 and to an external charger via fasteners 76 and wires 206, for charging batteries 60, 62.

Fasteners 76, in addition to securing bezel 72 and actuator/gasket 74 to the exterior of light 10 and module 100 therein, have respective heads that are exposed on the exterior of light 10 so as to serve to provide external contacts for making electrical connections between light 10 and an external source of charging current, e.g., a charging sleeve into which light 10 may be disposed, and fasteners 76 also provide internal connections to terminals 64, 66 of battery 60 via wires 206, circuit board 200 and spring contacts 164, 166, whereby battery 60 may be charged and/or recharged while remaining in light 10.

By way of assembly, circuit board 200 is assembled including having wires 206 and spring contacts 164, 166 soldered thereto, and having electronic components, e.g., switch 270, installed thereon. Circuit board 200 is placed into switch housing 120 and is secured therein by a fastener 202, with wires 206 of circuit board 200 extending into holes of extension 126 of housing 120. A base portion of coaxial contact springs 164, 166 may reside in one or more recesses at the rearward end of switch housing 120 so as to extend rearwardly therefrom for electrically contacting the terminals 64, 66 of battery 60, and the base ends of contact springs 164, 166 may be soldered or otherwise connected to circuit board 200.

In an arrangement thought to be preferred, one or more wire leads 262 may extend rearwardly from LED circuit board 265 of light source 250 through one or more openings in heat sink housing 110 into the recess in which control circuit board 200 resides, there to connect to control circuit board 200, e.g., by a connector 204 or by soldering. LED circuit board 265 has a source of light, e.g., a light emitting diode (LED) 270, mounted thereon, and may be placed in its recess of housing 110 either before or after installation of circuit board 200 in housing. The one or more leads from LED circuit board 265 may be soldered thereto for making electrical connection to LED 260. Circuit board 265 is thermally coupled to heat sink housing 110, e.g., by thermally conductive adhesive, thermal grease, or the like. Alternatively, thermally conductive heat sink 110 is in most instances also electrically conductive, e.g., may be made of aluminum, and so may be employed for making one of the connections between circuit board 200 and LED 260.

Alternatively, one of more wire leads may extend forwardly from circuit board 200 through one or more openings in heat sink housing 110 into the recess 105 in which LED circuit board 265 of light source 250 resides for being connected thereto, e.g., by soldering or another connection. LED circuit board 265 has a source of light, e.g., a light emitting diode (LED) 270, mounted thereon, and may be placed in its recess of housing 110 either before or after installation of circuit board 200 in housing.

Optionally, but preferably, reflector 50 may have one or more ears 52 extending rearwardly for making physical contact with housing/heat sink 110 and/or LED circuit board 265 which may assist in properly locating reflector 50 relative to LED 260 for shaping the light produced thereby and/or for providing a thermal path to the structure of reflector 50 for removing heat from LED 260, whereby reflector 50 may also serve as a heat sink Further, LED circuit board 265 may have thermally conductive vias or other features that conduct heat from LED 260 through circuit board 265 to module housing/heat sink 110, to aid in removing heat from LED 260. Module housing 110 may have one or more slots 115 therein for receiving one or more ears 52 of reflector 50 for facilitating orientation of reflector 50 relative thereto, and the forward end of module housing 110 may be formed, e.g., by having a beveled or chamfered edge on the forward opening thereof, also for properly locating reflector 50.

Reflector 50 may have, either additionally or alternatively, one or more projections 57 that engage one or more holes 267 in LED circuit board 265 and one or more corresponding holes 107 in module housing 110 of module 100, as can be seen in FIG. 5D, for aligning reflector 50, LED 260 and housing 110, e.g., so that LED 260 is properly located relative to the opening in the rearward end of reflector 50 and the reflective surface 51 therein. One ear 52 of reflector 50 is disposed in slot 152 of housing 110 for aligning reflector 50 therewith. In addition, such projections 57 and/or ears 52 of reflector 50 also reduce the risk of reflector 50 damaging LED 260 during assembly of light 10 or if light 10 is dropped.

Actuator 74 preferably has a raised region or button that extends outwardly through an opening in bezel 72 and that serves as an actuator button on the exterior of light 10 and preferably has a projection 75 that extends inwardly toward switch module 100 and is adjacent to actuator 278 of switch 270 of circuit board 200 so that pressing on the raised button of actuator 74 results in actuation of electrical switch 270, thereby to energize, operate and control light source 250 to produce and not produce light. Electrical switch 270 may provide one or more switch contacts and in a preferred arrangement provides two switch contacts. Preferably, the two switch contacts are momentary contacts that are normally open.

Electrical switch 270 preferably comprises a flexible metal dome 272 that is adjacent to control circuit board 200 for making and breaking contact between electrical conductors on circuit board 200. Typically flexible metal dome 272 has plural legs extending from a central dome that rest on one or more conductors of circuit board 200 so that when force is applied to the central dome thereof, the shape of flexible metal dome 272 changes and it makes contact with a conductor on circuit board 200. With a preferred flexible metal dome 272, when force is applied to the central dome thereof, one of the plural legs that is shorter makes contact with a conductor of circuit board 200 and when additional force is applied to the central dome thereof, the central dome makes contact with another conductor of circuit board 200.

Force is applied to flexible dome 272 via actuator 74 and switch elements 274-278. When force is applied to flexible actuator 74, the actuator region 78 on the rear thereof presses against actuator pushbutton 278 of electrical switch 270 which compresses spring 276 to apply force against plunger 274 thereof which applies the force to flexible metal dome 272 for causing flexing thereof for making electrical contact between particular electrical conductors of circuit board 200. Pushbutton 278, spring 276 and plunger 274 are movable toward and away from circuit board 200 and flexible dome 272 thereon in response to the force applied thereto, e.g., via actuator 74.

Examples of suitable arrangements for switch 270 may be found, e.g., in U.S. patent application Ser. No. 12/509,726 entitled “Electrical Switch Having Plural Switch Elements, as for Controlling a Flashlight” filed on Jul. 27, 2009 and published as U.S. Patent Publication No. 2009-0283390 on Nov. 19, 2009, and in U.S. Pat. No. 7,652,216 entitled “Electrical Switch, as for Controlling a Flashlight” issued on Jan. 6, 2010, each of which is assigned to Streamlight, Inc., the assignee of the present application, and is hereby incorporated herein by reference in its entirety for any and all purposes. An example of a light having a translucent bezel is described in U.S. Pat. No. 7,582,838 entitled “Flashlight Electrical Switch and Charging Indicator” issued on Sep. 1, 2009, which also is hereby incorporated herein by reference in its entirety for any and all purposes.

Further circuitry on circuit board 200 may include an indicator light that conveys information about the of operation of light 10 to a user. For example, a light emitting diode (LED) indicator D4 may be included on circuit board 200 for indicating operation of light 10. Preferably, LED D4 is turned ON in one or more different modes to indicate the status of light 10 when a battery B therein is being charged. Bezel 72 may preferably be completely or partially of a translucent material for allowing light produced by LED D4 to be perceived from outside of light 10, e.g., by a user when light 10 is in a charging sleeve. Bezel 72 may have a light passage 72L therein, e.g., defined by a conical projection 72L, as may be seen in FIG. 5B, that is substantially hollow so as to preferentially allow light produced by LED D4 to pass therethrough, and may, in addition, be tapered, e.g., may be a conical projection on its exterior surface that can be disposed in a hole 17 in light housing 22 and extending into module 100, e.g., for positively locating bezel 72, light housing 22 and module 100 relative to each other, whereby fasteners 76 may easily be installed in their respective proper locations.

The assembly of module 100 includes the mounting of circuit board 200 to switch housing 120 with extension 126 thereof disposed in opening 226 of circuit board 200 and with switch elements 272-278 of switch 270 in bore 127 of switch housing 120, and retaining circuit board 200 and switch 270 thereto by the installation of fastener 202 to retain it thereto. Bore 127 preferably has a shoulder therein that retains actuator 278 from passing through bore 127 whereby elements 272-278 of switch 270 are retained in switch housing 120. Switch housing 120 is then slipped into heat sink housing 110 with the generally rectangular portion containing switch actuator 278 disposed in the generally rectangular slot in housing 110 until substantially seated so that latch member 129 of switch housing 120 engages opening 117 in module housing 110, thereby to retain switch housing 120 therein. LED circuit board 165 is mounted to the generally flat and circular surface of heat sink housing 110 near the front thereof so as to be thermally coupled thereto and the ends of wires 262 thereof are connected to circuit board 200, e.g., by connector 204 and a complementary connector on wire or wires 262. Beneficially, with the preferred example arrangement illustrated, the various openings and projecting features of module housing 110, switch housing 120 and circuit board 200 serve to properly align the various elements of module 100, thereby facilitating assembly thereof.

Switch/LED module 100 is assembled to light body 20 or light housing 20 by slipping module 100 therein, e.g., through the opening at the front end 12 thereof, e.g., through the cylindrical and conical parts 42, 44 of head 40 thereof. Pushbutton 278 of switch 270 of module 100 is pressed into module 100 during insertion into light body 20 and tends to rise or “pop up” into opening 126 of light body 20 under the bias of spring 276 when module 100 is substantially properly positioned at opening 126 in light body 20. Actuator gasket 74 and bezel 72 are then placed against housing 20 and fasteners 76, 78 are installed to retain module 100 in housing 20 and to retain bezel 72 and gasket 74 thereon, all in their respective proper positions. Beneficially, with the preferred example arrangement illustrated, the various openings and projecting features of light body 20, module 100, switch bezel 72 and actuator-gasket 74 serve to properly align the various elements of light 10, thereby facilitating assembly thereof.

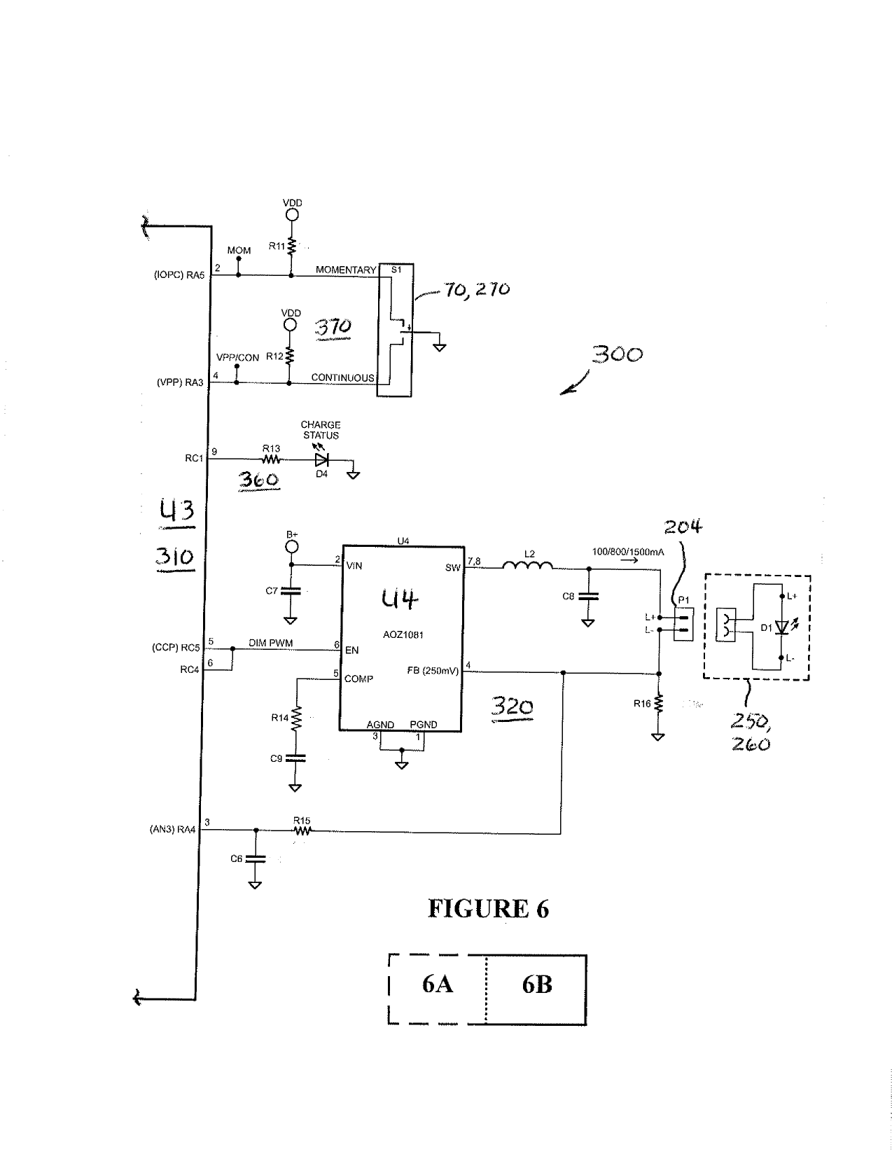

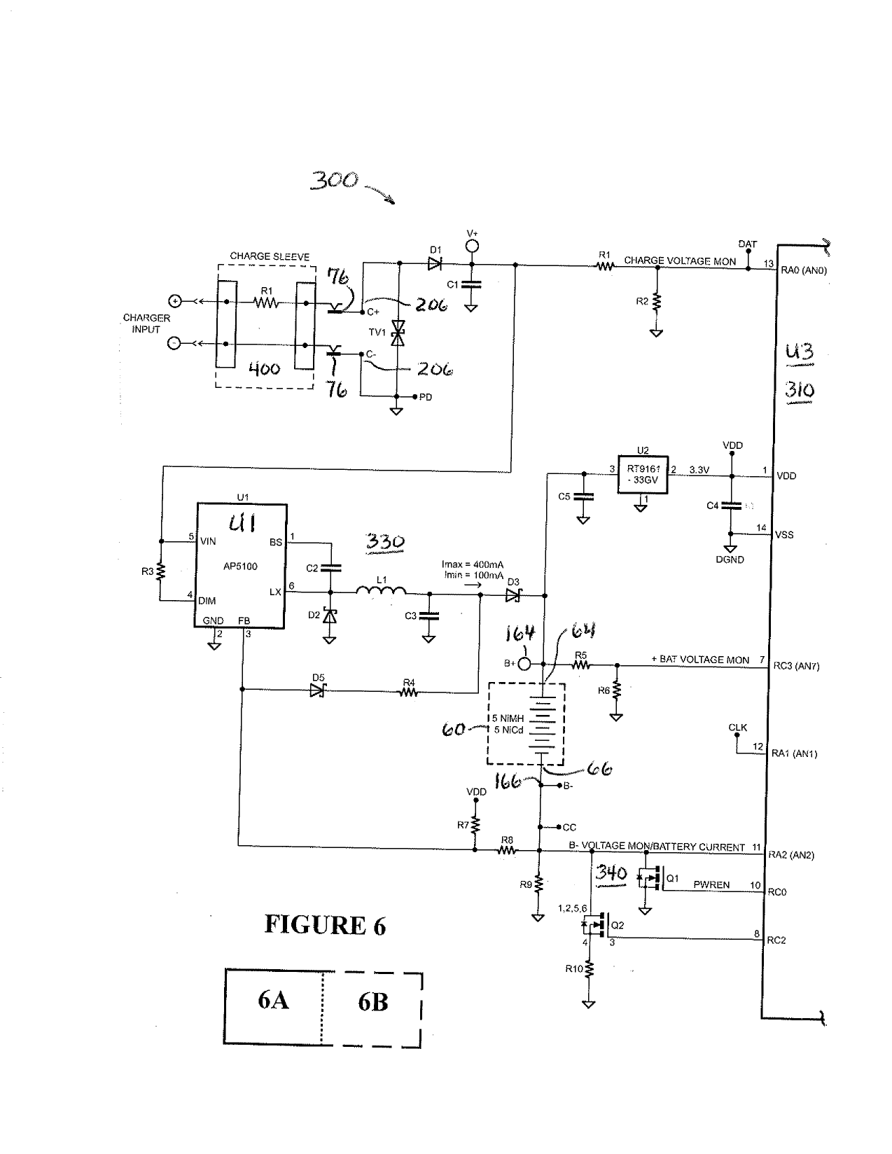

FIG. 6 is a schematic diagram of example electronic circuitry 300 suitable for use in the example embodiment of a flashlight 10. Electronic circuitry 300 is powered by battery B and is responsive to switch 270 of switch circuit 370 signaling controller 310 for controlling operation of LED current regulating circuit 320 to establish a desired level of current flowing through light source 250. Battery 60 provides electrical power for operating circuit 300 and light source 250. Power for operating light source 250 is provided directly from battery 60 (indicated as B+) to current controlling circuit 320 without the LED current passing through either electrical switch 270 or controller 310.

Among the functions of electronic circuitry 300 are controlling 320 the current flowing through LED light source 250, charging 330 battery 60 including selecting 340 the charging current level, providing 350 operating voltage to controller 310, indicating 360 the status of battery charging, and controlling 370 the operation of light source 250. Circuits 320, 330, 340, 350, 360, 370 providing each of the foregoing functions are described below.

Controller 310 is a digital micro-controller or micro-processor that has various input ports for receiving analog signals and/or digital signals and has various output ports at which it produces digital and/or analog output signals. Controller 310 has an internal memory for storing signal values and program instructions that define and direct the way in which controller 310 processes various digital and/or analog input signals and produces in response thereto various digital and/or analog output signals. One example of a suitable controller is a type PIC16F616 integrated circuit available from Microchip Technology, Inc. located in Chandler, Ariz.

Controller 310 in cooperation with other elements of circuit 300 produces signals that control operation of light source 250 responsive to commands signaled via switch 270, e.g., to operate current controller 320 to cause light source 250 to be in various modes of operation, e.g., to be ON momentarily, to be ON continuously, to be OFF, to be dimmed and or made brighter (un-dimmed), to flash, to blink, to be strobed, to signal data, or to be otherwise operated, as a user of light 10 may desire and command using switch 70, 270.

Current controlling circuit 320 controls the current flowing through light source, 250, e.g., LED 260, D1, responsive to control signals, e.g., pulse width modulated (PWM) signals, provided by controller 310 at its terminals 5-6. DC converter integrated circuit (IC) U4 contains switches and controls providing in cooperation with inductor L2 and capacitor C8 a PWM “buck” converter for producing the voltage applied to LED 260, D1, which voltage causes a current to flow through LED 260, D1. IC U4 controls LED current because the LED current flows through a current sensing resistor R16, the voltage across which provides feedback to IC U4 representing the LED current, whereby IC U4 controls the current in light source 250. Thus, the voltage produced across LED light source 250, 260 is not itself controlled, but it is controlled by DC converter U4 to be at a voltage value that produces the desired level of current flowing in LED 260, D1.

In one typical example light 10, controller 310 and current control 320 may operate to produce fixed levels of current of about 100 milliamperes, 800 milliamperes and 1500 milliamperes, responsive to commands from switch 70, 270. It is noted that current control 320 operates directly from battery voltage B+ and so the current applied to light source 250 does not flow through switch circuit 370 or through controller 310, and so electrical switch 270 is employed only as a signaling switch responsive to actuation by a user.

Optionally, but preferably, controller 310 may monitor the battery voltage B+ via resistors R5, R6 and the current through LED 260 and controller 310 may reduce the current to LED 260 when the battery voltage B+ decreases below a predetermined threshold, e.g., below about 4.5-5 volts, and such current reduction may be to one of the fixed levels of current or to another relatively lower level of current, including zero current to turn off LED 260.

Battery charging circuit 330 controls the current flowing into battery 60 when light 10 is placed into a charger sleeve 400 that receives electrical power from a charger 410, e.g., a power supply 410 producing a DC voltage when connected to a fixed AC power line, e.g., at 110 volts AC or 220 volts AC, or a power supply 410 producing a DC voltage when connected to a DC source, such as a 12 volt DC or 24 volt DC vehicle power source. Desirably, charger sleeve 400 for light 10 may be of similar size and shape as charger sleeves for earlier lights, and have contacts compatible with charging contacts 78, so that new lights may be charged using existing charging equipment. A voltage divider formed by resistors R1, R2 signals controller 310 that voltage from a charger 400, 410 is present, e.g., when light 10 is placed into charging sleeve 400, in response to which controller 310 enables charging circuit 330 to apply charging current to battery 60 of light 10.

DC converter IC U1 of charging circuit 330 operates in cooperation with inductor L1 and capacitor C3 as a buck voltage converter that applies DC voltage to charge battery 60 via diode D3. Battery voltage B+ is signaled to controller 310 at its terminal 7 via voltage divider R5, R6 and battery voltage B− is signaled directly at controller 310 terminal 11, whereby controller 310 controls IC U1 to limit the voltage to which battery 60 is charged. Resistors R9, R10 have the battery charging current following therethrough to provide feedback to controller 310 at its terminal 11 for controlling IC U1 to control the level of charging current actually flowing in battery 60. Selection circuit 340 includes FET transistors Q1, Q2 that are operated by controller 310 to select the value of the resistance in series with battery 60 for sensing the charging current, thereby enabling controller 310 to select, e.g., to reduce, the charging current when the battery voltage B+, B− (represented at its terminals 7 and 11) indicates that battery 60 has reached and/or is approaching full charge.

In one example light 10 wherein battery 60 comprises five NiCd or five NiMH battery cells 62, controller 310 and charging circuits 330, 340 typically operate to limit the battery charging current to about 400 milliamperes and reduce the charging current to about 100 milliamperes as battery 60 becomes fully charged.

Voltage supply circuit 350 operates from battery voltage B+ to provide a relatively fixed operating voltage VDD across capacitor C4 for operating controller 310, e.g., a voltage of about 3.3 volts DC, and for operating other circuits for which a relatively fixed operating voltage is desired, e.g., for switch circuit 370.

Charging indicator circuit 360 includes a light emitting diode D4 that is operated by controller 310 to produce light to indicate the status of the charging of battery 60. Although many indications may be utilized, LED D4 may typically be turned ON and OFF, e.g., strobed ON, relatively slowly, e.g., at about 1-2 Hertz, to indicate that battery 60 is substantially fully charged, may be continuously ON to indicate that battery 60 is receiving charging current, and may flash ON and OFF relatively rapidly, e.g., at about 8 Hertz, to indicate a charging error, such as no battery or a high resistance battery in light 10 or that the charging current is too high. When light 10 is not in a charging sleeve 400 or when electrical power is not applied to a charging sleeve 400 that light 10 is in, LED D4 typically is OFF.

Switching circuit 370 includes a switch 270 that has, e.g., two momentary contacts, each of which is connected to a different terminal of controller 310, each having a resistor R11, R12 pull-up circuit. Closures of the two contacts of switch 270, which can be effected by actuating switch 270, e.g., by pressing pushbutton 272 thereof via actuator 74, are employed to signal commands to controller 310, and the signaling may include sequences of switch contact closures, numbers of switch contact closures and/or frequency of switch contact closures, e.g., for signaling controller 310 to place light 10 into a particular operating mode as indicated by the timing and number of switch closures.

For example, simply holding the first contact closed could cause controller 310 to operate light source 250 in a momentarily ON mode, e.g., ON for as long as the contact is maintained closed. A momentary closure of the second contact, or of both contacts, could signal controller 310 to operate light source 250 in a continuous ON mode if it is OFF and to turn light source 250 OFF if it is ON. In a further example, maintaining one or both contacts closed, e.g., by actuating switch 270, for longer than a predetermined time, e.g., 2-3 seconds, could signal controller 310 to operate light source in a continuous ON mode while cycling through a series of dimmer and brighter light output states, with the level of light output maintained at the level it is at when the contacts are opened, e.g., by releasing switch 270. “Double clicking” switch 270 could signal controller 310 to operate light source 250 in a flashing or blinking mode. Of course, different signaling times and sequences may be utilized.

In a typical embodiment, light body/housing 20 may be of a plastic material, e.g., of a nylon, a reinforced nylon, ABS, polycarbonate, or another plastic, or a metal, e.g., an aluminum, brass or titanium, and module 100 may have a heat sink housing 110 of aluminum, brass, copper, or another suitable thermally conductive metal or plastic material, and switch module 120 may be of a acetal plastic, nylon, ABS, polycarbonate, or other suitable plastic or other electrically insulating material. Battery 60 may include plural rechargeable battery cells 62 in a single physical package, e.g., retained by a plastic or other sleeve, and each battery cell 62 may be a nickel-cadmium, nickel-metal hydride, or lithium-ion battery cell, or may be another rechargeable battery chemistry type. Typical batteries in one embodiment include five nickel-cadmium cell or five nickel-metal hydride cells of approximately the “C” size.

A light 10 and module 100 may comprise: a light housing 20 having at least one cavity therein for receiving a module 100 and a source of electrical power 60; a module 100 having an exterior size and shape wherein the module 100 is disposed in the at least one cavity of the light housing 20, the module 100 comprising: a module housing 110 generally defining a substantial portion of the exterior size and shape of the module 100, the module housing 110 including a thermally conductive material; a light source 250 mounted to the module housing 110 and thermally coupled thereto, the light source 250 producing light when energized; a switch housing 120 engaging the module housing 110 and generally defining another substantial portion of the exterior size and shape of the module 100, the switch housing 120 including an electrical switch 70, 270, wherein the electrical switch 70, 270 has an actuator 74, 278 actuatable from exterior the module 100; at least one electrical contact 164, 166 extending from the module 100 for making electrical connection to a source of electrical power 60 when a source of electrical power 60 is in the at least one cavity of the light housing 20; and a control circuit 300 coupled to the light source 250 and to the at least one electrical contact 164, 166 for controlling energization of the light source 250 responsive to actuation of the electrical switch 70, 270; a reflector 50 adjacent the light source 250 for directing light produced thereby through an open end of the reflector 50; and a lens retainer 48 retaining a lens adjacent the open end of the reflector 50; the light housing 20 having an opening wherein the actuator 74, 278 of the electrical switch 70, 270 is actuatable from exterior the light housing 20. The exterior size and shape of the module 100 may be generally cylindrical, wherein the actuator 278 of the electrical switch 70, 270 is movable radially relative to a cylindrical surface of the module 100, wherein the light source 250 may be mounted to a generally planar surface proximate one end of the cylindrical shape of the module 100, and wherein the at least one electrical contact 164, 166 may extend from an end of the module 100 opposite the surface to which the light source 250 is mounted. The actuator 278 of the electrical switch 70, 270 may be proximate an opening in the light housing 20, the light housing 20 including a bezel 72 and a resilient actuator 74 opposing the actuator 278 of the electrical switch 70, 270, whereby the electrical switch 70, 270 is actuatable from exterior the light housing 20 via the resilient actuator 74. The bezel 72 and resilient actuator 74 may be secured to the light housing 20 by one or more fasteners 76, 78, wherein the one or more fasteners 76, 78 extend through the light housing 20 to engage the module 100. At least one of the one or more fasteners 76, 78 is electrically conductive, the at least one electrically conductive fastener 76 having a head accessible from exterior the light housing 20 for providing an exterior electrical contact 76, and wherein the at least one electrically conductive fastener 76 makes electrical connection to the control circuit 300, whereby electrical connection may be made to the control circuit 300 from exterior the light 10 and module 100 via the at least one electrically conductive fastener 76. The light 10 and module 100 may further comprise a rechargeable source of electrical power 60 in the at least one cavity of the light housing 20, wherein: the at least one electrically conductive fastener 76 provides a connection for charging the rechargeable source of electrical power 60; or the rechargeable source of electrical power 60 includes a rechargeable battery, and the at least one electrically conductive fastener 76 provides a connection for charging the rechargeable battery. The control circuit 300 may include an indicator light D4 proximate the bezel 72 for indicating an operating status of the light 10 and module 100, wherein the bezel 72 is translucent or transparent whereby light produced by the indicator light D4 is visible exterior the light 10. The switch housing 120 may have a recess therein and the bezel 72 may have a projection extending through an opening in the light housing 20 into the recess of the switch housing 120, thereby to position the bezel 72 and the module 100 in predetermined positions on the light housing 20. The module housing 110 may have a generally rectangular slot and the switch housing 120 may have a generally rectangular raised feature disposed in the generally rectangular slot of the module housing 110. The actuator 278 of the electrical switch 70, 270 is movable in an opening in the rectangular raised feature of the switch housing 120 and is captive therein. The switch housing 120 may have a latch member 129 that engages an opening of the module housing 110 for retaining the switch housing 120 therein. The light 10 and module 100 may further comprise an electronic circuit board 200, wherein the electronic circuit board 200 is supported by the switch housing 120 and includes at least a part of the control circuit 300 and at least one contact of the electrical switch 70, 270. The at least one electrical contact 164, 166 extending from the module 100 may include two coaxial electrically conductive springs 164, 166.

A light module 100 may comprise: a module 100 having an exterior size and shape wherein the module 100 is disposable in a cavity of a light housing 20, the module 100 comprising: a module housing 110 generally defining a substantial portion of the exterior size and shape of the module 100, the module housing 110 including a thermally conductive material; a light source 250 mounted to the module housing 110 and thermally coupled thereto, the light source 250 producing light when energized; a switch housing 120 engaging the module housing 110 and generally defining another substantial portion of the exterior size and shape of the module 100, the switch housing 120 including an electrical switch 70, 270, wherein the electrical switch 70, 270 has an actuator 278 actuatable from exterior the module 100; at least one electrical contact 164, 166 extending from the module 100 for making electrical connection to a source of electrical power 60; and a control circuit 300 coupled to the light source 250 and to the at least one electrical contact 164, 166 for controlling energization of the light source 250 responsive to actuation of the electrical switch 70, 270. The exterior size and shape may be generally cylindrical, wherein the actuator 278 of the electrical switch 70, 270 is movable radially relative to a cylindrical surface of the module 100, wherein the light source 250 is mounted to a generally planar surface proximate one end of the cylindrical shape of the module 100, and wherein the at least one electrical contact 164, 166 extends from an end of the module 100 opposite the surface to which the light source 250 is mounted. The actuator 278 of the electrical switch 70, 270 is movable for being located proximate to an opening in a light housing 20 into which the light module 100 is insertable, wherein a resilient actuator 74 may oppose the actuator 278 of the electrical switch 70, 270, whereby the electrical switch 70, 270 is actuatable from exterior the light module 100 via the resilient actuator 74. The light module 100 may be securable in a light housing 20 by one or more fasteners 76, 78, wherein at least one of the one or more fasteners 76, 78 is electrically conductive and has a head accessible from exterior the light module 100 for providing an exterior electrical contact 76, and wherein the at least one electrically conductive fastener 76 makes electrical connection to the control circuit 300, whereby electrical connection may be made to the control circuit 300 from exterior the light module 100 via the at least one electrically conductive fastener 76. The light module 100 may be employed in combination with a rechargeable source of electrical power 60, wherein the at least one electrically conductive fastener 76 provides a connection for charging the rechargeable source of electrical power 60; or the rechargeable source of electrical power 60 includes a rechargeable battery, and the at least one electrically conductive fastener 76 provides a connection for charging the rechargeable battery. The control circuit 300 may include an indicator light D4 for indicating an operating status of the light module 100, wherein the light module 100 has an opening through which light produced by the indicator light D4 is visible exterior the light module 100. The module housing 110 may have a generally rectangular slot and the switch housing 120 may have a generally rectangular raised feature disposed in the generally rectangular slot of the module housing 110. The actuator 278 of the electrical switch 70, 270 is movable in an opening in the rectangular raised feature of the switch housing 120 and is captive therein. The switch housing 120 may have a latch member 129 that engages an opening of the module housing 110 for retaining the switch housing 120 therein. The light module 100 may further comprise an electronic circuit board 200, wherein the electronic circuit board 200 is supported by the switch housing 120 and includes at least a part of the control circuit 300 and at least one contact of the electrical switch 70, 270. The at least one electrical contact 164, 166 extending from the module 100 may include two coaxial electrically conductive springs 164, 166.

A light module 100 may comprise: a module 100 having a generally cylindrical exterior size and shape wherein the module 100 is disposable in a generally cylindrical cavity of a light housing 20, the module 100 comprising: a module housing 110 generally defining a substantial portion of the generally cylindrical exterior size and shape of the module 100, the module housing 110 including a thermally conductive material; a light source 250 mounted to a generally planar surface proximate one end of the generally cylindrical shape of the module housing 110 and thermally coupled thereto, the light source 250 producing light when energized; a switch housing 120 engaging the module housing 110 and generally defining another substantial portion of the generally cylindrical exterior size and shape of the module 100, the switch housing 120 including an electrical switch 70, 270, wherein the electrical switch 70, 270 has an actuator 278 movable radially relative to a cylindrical surface of the module 100 and actuatable from exterior the module 100; at least one electrical contact 164, 166 extending from an end of the module 100 opposite the surface to which the light source 250 is mounted for making electrical connection to a source of electrical power 60; and a circuit board 200 including a control circuit 300 coupled to the light source 250 and to the at least two electrical contacts 164, 166 for controlling energization of the light source 250 responsive to actuation of the electrical switch 70, 270, wherein the light module 100 is securable in a light housing 20 by one or more fasteners 76, 78 engaging the switch housing 120, wherein at least one of the one or more fasteners 76, 78 is electrically conductive and has a head accessible from exterior the light module 100 for providing an exterior electrical contact 76, and wherein the at least one electrically conductive fastener 76 makes electrical connection to the control circuit 300, whereby electrical connection may be made to the control circuit 300 from exterior the light module 100 via the at least one electrically conductive fastener 76. The actuator 278 of the electrical switch 70, 270 may be movable for being located proximate to an opening in a light housing 20 into which the light module 100 is insertable, wherein a resilient actuator 74 may oppose the actuator 278 of the electrical switch 70, 270, whereby the electrical switch 70, 270 is actuatable from exterior the light module 100 via the resilient actuator 74. The light module 100 may be employed in combination with a rechargeable source of electrical power 60, wherein the at least one electrically conductive fastener 76 provides a connection for charging the rechargeable source of electrical power 60; or the rechargeable source of electrical power 60 includes a rechargeable battery, and the at least one electrically conductive fastener 76 provides a connection for charging the rechargeable battery. The control circuit 300 may include an indicator light D4 for indicating an operating status of the light module 100, wherein the light module 100 has an opening through which light produced by the indicator light D4 is visible exterior the light module 100. The module housing 110 may have a generally rectangular slot and the switch housing 120 has a generally rectangular raised feature disposed in the generally rectangular slot of the module housing 110. The actuator 278 of the electrical switch 70, 270 is movable in an opening in the rectangular raised feature of the switch housing 120 and is captive therein. The switch housing 120 may have a latch member 129 that engages an opening of the module housing 110 for retaining the switch housing 120 therein. The electronic circuit board 200 may include at least one contact of the electrical switch 70, 270. The at least one electrical contact 164, 166 extending from the module 100 may include two coaxial electrically conductive springs 164, 166.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Although terms such as “up,” “down,” “left,” “right,” “front,” “rear,” “side,” “top,” “bottom,” “forward,” “backward,” “under” and/or “over,” and the like may be used herein as a convenience in describing one or more embodiments and/or uses of the present arrangement, the articles described may be positioned in any desired orientation and/or may be utilized in any desired position and/or orientation. Such terms of position and/or orientation should be understood as being for convenience only, and not as limiting of the invention as claimed.

Further, what is stated as being “optimum” or “deemed optimum” may or may not be a true optimum condition, but is the condition deemed to be desirable or acceptably “optimum” by virtue of its being selected in accordance with the decision rules and/or criteria defined by the designer and/or applicable controlling function.

The term battery is used herein to refer to an electro-chemical device comprising one or more electro-chemical cells and/or fuel cells, and so a battery may include a single cell or plural cells, whether as individual units or as a packaged unit. A battery is one example of a type of an electrical power source suitable for a portable device.

While the present invention has been described in terms of the foregoing example embodiments, variations within the scope and spirit of the present invention as defined by the claims following will be apparent to those skilled in the art. For example, while the charging contacts provided by the respective heads of fasteners 76 are illustrated as being on the cylindrical housing portion of light housing/body 20, they may be located on head portion 40 or on both housing portion 22 and head portion 40, or on another portion of light body 20, as may be convenient and/or desirable in a particular embodiment.

Either or both of reflector 50 and/or switch housing 120 may be made of a thermally conductive material, e.g., a thermally loaded plastic or aluminum with an insulating coating, for conducting heat generated by operation of light source 250, thereby to cooperate with heat sink housing 110 and/or thermally conductive circuit board 265 for controlling the temperature rise of, e.g., LED 260.

While the example embodiment employs a solid state light source, e.g., an LED, the light and module 100 herein may employ a non-solid state light source, e.g., an incandescent, xenon, halogen, high-intensity discharge, or other lamp.

While light 10 is illustrated as having a lens retainer 48 that has external threads that engage internal threads of head 40, such lens retainer 48 often being referred to as a lens ring, a lens retainer 48 having internal threads that engage external threads of head 40, such lens retainer 48 often being referred to as a face cap, may be employed.

Further, the formed forward end of housing 22 or a longitudinal rib on the interior of head 40 may be provided for depressing switch actuator 278 of module 100 during insertion of module 100 into light body 20 of light 10. Alternatively, a tool, e.g., an elongated tool, may be utilized to depress actuator 278 during assembly into light housing 20.

Each of the U.S. Provisional Applications, U.S. patent applications, and/or U.S. patents identified herein are hereby incorporated herein by reference in their entirety, for any purpose and for all purposes irrespective of how it may be referred to herein.

Finally, numerical values stated are typical or example values, are not limiting values, and do not preclude substantially larger and/or substantially smaller values. Values in any given embodiment may be substantially larger and/or may be substantially smaller than the example or typical values stated.

What is claimed is:

1. A light and module comprising:
a light housing having at least one cavity therein for receiving a module and a source of electrical power;
a module having an exterior size and shape wherein the module is disposed in the at least one cavity of said light housing, said module comprising:
a module housing generally defining a substantial portion of the exterior size and shape of said module, said module housing including a thermally conductive material;
a light source mounted to said module housing and thermally coupled thereto, said light source producing light when energized;
a switch housing engaging said module housing and generally defining another substantial portion of the exterior size and shape of said module, said switch housing including an electrical switch, wherein said electrical switch has an actuator actuatable from exterior said module;
at least one electrical contact extending from said module for making electrical connection to a source of electrical power when a source of electrical power is in the at least one cavity of said light housing; and
a control circuit coupled to said light source and to said at least one electrical contact for controlling energization of said light source responsive to actuation of said electrical switch;
a reflector adjacent said light source for directing light produced thereby through an open end of said reflector; and
a lens retainer retaining a lens adjacent the open end of said reflector;
said light housing having an opening wherein the actuator of said electrical switch is actuatable from exterior said light housing.

2. The light and module of claim 1 wherein the exterior size and shape of said module is generally cylindrical, wherein the actuator of said electrical switch is movable radially relative to a cylindrical surface of said module, wherein said light source is mounted to a generally planar surface proximate one end of the cylindrical shape of said module, and wherein said at least one electrical contact extends from an end of said module opposite the surface to which said light source is mounted.

3. The light and module of claim 1 wherein the actuator of said electrical switch is proximate an opening in said light housing, said light housing including a bezel and a resilient actuator opposing the actuator of said electrical switch, whereby said electrical switch is actuatable from exterior said light housing via said resilient actuator.

4. The light and module of claim 3 wherein said bezel and resilient actuator are secured to said light housing by one or more fasteners, wherein said one or more fasteners extend through said light housing to engage said module.

5. The light and module of claim 4 wherein at least one of said one or more fasteners is electrically conductive, said at least one electrically conductive fastener having a head accessible from exterior said light housing for providing an exterior electrical contact, and wherein said at least one electrically conductive fastener makes electrical connection to said control circuit, whereby electrical connection may be made to said control circuit from exterior said light and module via said at least one electrically conductive fastener.

6. The light and module of claim 5 further comprising a rechargeable source of electrical power in the at least one cavity of said light housing, wherein:
said at least one electrically conductive fastener provides a connection for charging said rechargeable source of electrical power; or
said rechargeable source of electrical power includes a rechargeable battery, and said at least one electrically conductive fastener provides a connection for charging said rechargeable battery.

7. The light and module of claim 4 wherein said control circuit includes an indicator light proximate said bezel for indicating an operating status of said light and module, wherein said bezel is translucent or transparent whereby light produced by said indicator light is visible exterior said light and module.

8. The light and module of claim 1 wherein said switch housing has a recess therein and wherein said bezel has a projection extending through an opening in said light housing into the recess of said switch housing, thereby to position said bezel and said module in predetermined positions on said light housing.

9. The light and module of claim 1 wherein said module housing has a generally rectangular slot and said switch housing has a generally rectangular raised feature disposed in the generally rectangular slot of said module housing.

10. The light and module of claim 9 wherein the actuator of said electrical switch is movable in an opening in the rectangular raised feature of said switch housing and is captive therein.

11. The light and module of claim 1 wherein said switch housing has a latch member that engages an opening of said module housing for retaining said switch housing therein.

12. The light and module of claim 1 further comprising an electronic circuit board, wherein said electronic circuit board is supported by said switch housing and includes at least a part of said control circuit and at least one contact of said electrical switch.

13. The light and module of claim 1 wherein said at least one electrical contact extending from said module includes two coaxial electrically conductive springs.

14. A light module comprising:
a module having an exterior size and shape wherein the module is disposable in a cavity of a light housing, said module comprising:
a module housing generally defining a substantial portion of the exterior size and shape of said module, said module housing including a thermally conductive material;
a light source mounted to said module housing and thermally coupled thereto, said light source producing light when energized;
a switch housing engaging said module housing and generally defining another substantial portion of the exterior size and shape of said module, said switch housing including an electrical switch, wherein said electrical switch has an actuator actuatable from exterior said module;
at least one electrical contact extending from said module for making electrical connection to a source of electrical power; and
a control circuit coupled to said light source and to said at least one electrical contact for controlling energization of said light source responsive to actuation of said electrical switch.

15. The light module of claim 14 wherein the exterior size and shape is generally cylindrical, wherein the actuator of said electrical switch is movable radially relative to a cylindrical surface of said module, wherein said light source is mounted to a generally planar surface proximate one end of the cylindrical shape of said module, and wherein said at least one electrical contact extends from an end of said module opposite the surface to which said light source is mounted.

16. The light module of claim 14 wherein the actuator of said electrical switch is movable for being located proximate to an opening in a light housing into which said light module is insertable, wherein a resilient actuator may oppose the actuator of said electrical switch, whereby said electrical switch is actuatable from exterior said light module via the resilient actuator.

17. The light module of claim 14 wherein said light module is securable in a light housing by one or more fasteners, wherein at least one of said one or more fasteners is electrically conductive and has a head accessible from exterior said light module for providing an exterior electrical contact, and wherein said at least one electrically conductive fastener makes electrical connection to said control circuit, whereby electrical connection may be made to said control circuit from exterior said light module via said at least one electrically conductive fastener.

18. The light module of claim 17 in combination with a rechargeable source of electrical power, wherein
said at least one electrically conductive fastener provides a connection for charging said rechargeable source of electrical power; or
said rechargeable source of electrical power includes a rechargeable battery, and said at least one electrically conductive fastener provides a connection for charging said rechargeable battery.

19. The light module of claim 14 wherein said control circuit includes an indicator light for indicating an operating status of said light module, wherein said light module has an opening through which light produced by said indicator light is visible exterior said light module.

20. The light module of claim 14 wherein said module housing has a generally rectangular slot and said switch housing has a generally rectangular raised feature disposed in the generally rectangular slot of said module housing.

21. The light module of claim 20 wherein the actuator of said electrical switch is movable in an opening in the rectangular raised feature of said switch housing and is captive therein.

22. The light module of claim 14 wherein said switch housing has a latch member that engages an opening of said module housing for retaining said switch housing therein.

23. The light module of claim 14 further comprising an electronic circuit board, wherein said electronic circuit board is supported by said switch housing and includes at least a part of said control circuit and at least one contact of said electrical switch.

24. The light module of claim 14 wherein said at least one electrical contact extending from said module includes two coaxial electrically conductive springs.

25. A light module comprising:
a module having a generally cylindrical exterior size and shape wherein the module is disposable in a generally cylindrical cavity of a light housing, said module comprising:
a module housing generally defining a substantial portion of the generally cylindrical exterior size and shape of said module, said module housing including a thermally conductive material;
a light source mounted to a generally planar surface proximate one end of the generally cylindrical shape of said module housing and thermally coupled thereto, said light source producing light when energized;
a switch housing engaging said module housing and generally defining another substantial portion of the generally cylindrical exterior size and shape of said module, said switch housing including an electrical switch, wherein said electrical switch has an actuator movable radially relative to a cylindrical surface of said module and actuatable from exterior said module;
at least one electrical contact extending from an end of said module opposite the surface to which said light source is mounted for making electrical connection to a source of electrical power; and
a circuit board including a control circuit coupled to said light source and to said at least two electrical contacts for controlling energization of said light source responsive to actuation of said electrical switch,
wherein said light module is securable in a light housing by one or more fasteners engaging said switch housing, wherein at least one of said one or more fasteners is electrically conductive and has a head accessible from exterior said light module for providing an exterior electrical contact, and wherein said at least one electrically conductive fastener makes electrical connection to said control circuit, whereby electrical connection may be made to said control circuit from exterior said light module via said at least one electrically conductive fastener.

26. The light module of claim 25 wherein the actuator of said electrical switch is movable for being located proximate to an opening in a light housing into which said light module is insertable, wherein a resilient actuator may oppose the actuator of said electrical switch, whereby said electrical switch is actuatable from exterior said light module via the resilient actuator.

27. The light module of claim 25 in combination with a rechargeable source of electrical power, wherein
said at least one electrically conductive fastener provides a connection for charging said rechargeable source of electrical power; or
said rechargeable source of electrical power includes a rechargeable battery, and said at least one electrically conductive fastener provides a connection for charging said rechargeable battery.

28. The light module of claim 25 wherein said control circuit includes an indicator light for indicating an operating status of said light module, wherein said light module has an opening through which light produced by said indicator light is visible exterior said light module.

29. The light module of claim 25 wherein said module housing has a generally rectangular slot and said switch housing has a generally rectangular raised feature disposed in the generally rectangular slot of said module housing.

30. The light module of claim 29 wherein the actuator of said electrical switch is movable in an opening in the rectangular raised feature of said switch housing and is captive therein.

31. The light module of claim 25 wherein said switch housing has a latch member that engages an opening of said module housing for retaining said switch housing therein.

32. The light module of claim 25 wherein said electronic circuit board includes at least one contact of said electrical switch.

33. The light module of claim 25 wherein said at least one electrical contact extending from said module includes two coaxial electrically conductive springs.
